(19) United States
(12) Patent Application Publication
(10) Pub. No.: US 2009/0016676 A1
(43) Pub. Date: Jan. 15, 2009

(54) Optical element, optical module holder including optical element, optical module, and optical connector

(75) Inventor: Shimpei Morioka, Kawaguchi-shi (JP)

Correspondence Address: Quinn Emanuel Urquhart Oliver & Hedges, LLP;Koda/Androlia, 865 S. Figueroa Street, 10th Floor, Los Angeles, CA, 90017, US

(73) Assignee: Enplas Corporation

(21) Appl. No.: 12/217,678

(22) Filed: Jul. 8, 2008

(30) Foreign Application Priority Data
Jul. 9, 2007 (JP) 2007-179808

(51) Int. Cl. G02B 6/26

(52) U.S. Cl. 385/27

(57) ABSTRACT

An optical element, an optical module holder including the optical element, an optical module, and an optical connector are provided that can suppress, at a low cost, a change in an intensity of a light that is emitted from a photoelectric conversion:element and coupled to an end section of an optical transmission path, the change accompanying a change in an usage environment temperature, perform a stable optical communication having a superior heat resistance property at a low cost, and can achieve size reduction and improved versatility.

A diffraction grating 17 is formed to suppress, to within a predetermined allowable limit, a coupled light temperature characteristic indicating a change in an intensity of a light of a specific diffractive order that is coupled to an end section of an optical transmission line 12, the change accompanying a change in a usage environment temperature of a photoelectric converter 8.

### BACKGROUND OF THE INVENTION

1. Field of the Invention

The present invention relates to an optical element, an optical module holder including the optical element, an optical module, and an optical connector. In particular, the present invention relates to an optical element, an optical module holder including the optical element, an optical module, and an optical connector that are suitable for coupling a light emitted from a photoelectric conversion element to an end section of an optical transmission line.

2. Description of the Related Art

In recent years, with increasing speed and capacity of data communication, the need is further rising for an optical fiber communication technology using an optical fiber.

As an optical module used in an optical fiber communication such as this, an optical module in which an optical fiber and a photoelectric conversion element (such as a semiconductor laser) are attached to an optical module holder is known. The optical module holder has an optical element on which an optical surface, such as a lens surface, is formed.

In an optical module such as that described above, a light including transmission information emitted from the photoelectric conversion element is optically coupled to an end section of the optical fiber using light transmission and refraction caused by the optical surface of the optical element.

Moreover, since the past, in an optical communication using the above-described kind of optical fiber, attenuation of an amount of light (namely, light intensity) coupled between the photoelectric conversion element and the optical fiber via the optical element has been often demanded due to reasons related to communication standards, safety, and the like. In response to such demands, since the past, the optical element has been provided with a diffraction grating serving as a light amount attenuating means (refer to, for example, Patent Literature 1).

In such an optical element including the diffraction grating, the amount of light coupled to the end section of the optical fiber can be attenuated by a light entering from the photoelectric conversion element side being diffracted and allowing only a light of a specific diffractive order to be coupled to the end section of the optical fiber.

Patent Literature 1: Japanese Patent Laid-open Publication No. Heisei 11-142696

A semiconductor laser serving as a photoelectric conversion element is generally known to have a characteristic in that an intensity of an emitted light (laser light), namely an output, changes depending on a usage environment temperature of the semiconductor laser.

Here, FIG. 7 shows a graph of a characteristic of an output [mW] of the light emitted from the semiconductor laser in relation to an electric current [mA] supplied to the semiconductor layer when the usage environment temperature is T₁[° C.] and a characteristic of an output [mW] of the light emitted from the semiconductor laser in relation to the electric current [mA] supplied to the semiconductor layer when the usage environment temperature is T₂[° C.]. T₂ is a higher temperature than T₁.

As shown in FIG. 7, in the semiconductor laser, the output increases when the supplied electric current increases. An output actually used in the optical communication is an output of when the supplied electric current is equal to or more than a predetermined threshold current.

As is made clear in FIG. 7, the semiconductor laser has a characteristic in that, between the usage environment temperature of T₁ and T₂, the output at the high temperature T₂ is smaller.

When the semiconductor laser having a characteristic such as that described above is mounted on the above-described optical module including the diffraction grating serving as the light amount attenuating means, in accompaniment with changes in the output [mW] and intensity [mW/cm²] of the light emitted from the semiconductor laser caused by the change in the usage environment temperature, an intensity of the light of the specific diffractive order coupled to the end section of the optical fiber via the diffraction grating after being emitted from the semiconductor laser also changes.

Changes in the intensity of the light coupled to the end section of the optical fiber as described above is not favorable for performing a stable optical communication (transmission) with little communication error.

Regarding this, it is thought that the output from the semiconductor laser can be kept constant regardless of the change in the usage environment temperature when, for example, the electric current supplied to the semiconductor laser is adjusted to increase with the rise in the usage environment temperature. In the example in FIG. 7, when the usage environment temperature rises to T2 from a state in which an electric current I₁ is supplied and an output P is obtained when the usage environment temperature is T1, the electric current is increased to I₂ to achieve the same output P.

To actualize adjustment of the electric current supplied to the semiconductor laser as that describe above, an adjustment mechanism for adjusting the electric current in adherence to the change in the usage environment temperature is required. The adjustment mechanism can include, for example, a light receiving element 24 such as a photodiode integrated circuit (PDIC), a glass window 25 of a controller-area network (CAN) package 22, and a control circuit (not shown), as shown in an optical module 23 in FIG. 8. The light receiving element 24 is disposed near a semiconductor laser 8. The glass window 25 reflects a portion of a light emitted from the semiconductor laser 8 towards the light receiving element 24 side. The control circuit controls an electric current supplied to the semiconductor laser 8 such as to resolve changes in an intensity of the light received by the light receiving element 24. The optical module in FIG. 8 includes a planoconvex lens 27 that optically couples the semiconductor laser 8 and an end section of an optical fiber. In an adjustment mechanism such as this, upon grasping a change in the usage environment temperature of the semiconductor laser 8 as a change in the intensity of the light emitted from the semiconductor 8 and fed back to the light receiving element 24, the supply of electric current to the semiconductor laser 8 can be controlled in adherence to the usage environment temperature.

However, in an adjustment mechanism such as this, not only does a number of components increase, but because the adjustment of the electric current supplied to the semiconductor laser requires high accuracy, an increase in cost becomes unavoidable. Moreover, an adjustment mechanism such as this is customized for a CAN package-type semiconductor laser that can include a glass window. The adjustment mechanism cannot be applied to a surface-mounted semiconductor laser that does not have a glass window but is suitable for size reduction. Therefore, size reduction becomes difficult to achieve, and the adjustment mechanism lacks versatility.

Therefore, conventionally, a problem arose in that the change in the intensity of the light emitted from the photoelectric conversion element and coupled to the end section of the optical transmission line accompanying the change in the usage environment temperature cannot be suppressed at a low cost.

### SUMMARY OF THE INVENTION

Therefore, the present invention has been achieved in light of the above-described issues. An object of the present invention is to provide an optical element, an optical module holder including the optical element, an optical module, and an optical connector that can suppress, at a low cost, a change in an intensity of a light that is emitted from a photoelectric conversion element and coupled to an end section of an optical transmission path, the change accompanying a change in an usage environment temperature, and perform a stable optical communication having a superior heat resistance property at a low cost.

In order to achieve the aforementioned object, an optical element according to a first aspect of the present invention, in a state in which the optical element is disposed on an optical path between an optical transmission line and a photoelectric conversion element capable of emitting light by an electric current being supplied, couples a light emitted from the photoelectric conversion element to an end section of the optical transmission line. The optical element includes a diffraction grating that diffracts light entering from the photoelectric conversion element side and couples a light of a specific diffractive order to the end section of the optical transmission line. The diffraction grating is formed to suppress a coupled light temperature characteristic to within a predetermined allowable limit. The coupled light temperature characteristic indicates a change in an intensity of the light coupled to the end section of the optical transmission that accompanies a change in a usage environment temperature of the photoelectric conversion element.

In the first aspect of the invention, even when an adjustment mechanism for adjusting the electric current supplied to the photoelectric conversion element in adherence to the usage environment temperature is not used, or when a low-cost adjustment mechanism that cannot adjust the electric current supplied to the photoelectric conversion element with high accuracy is used, the diffraction grating can suppress the coupled light temperature characteristic to within the allowable limit. As a result, a change in an intensity of the light of a specific diffractive order coupled to the end section of the optical transmission line that accompanies the change in the usage environment temperature can be suppressed at a low cost. An optical element can be actualized that can perform a stable optical communication with a superior heat resistance property at a low cost. Because the adjustment mechanism is not used, size reduction of the optical module can be achieved through use of a surface-mounted photoelectric conversion element. Moreover, because both the CAN package-type and the surface-mounted photoelectric conversion elements can be used, versatility can be improved.

An optical element according to a second aspect is the optical element according to the first aspect in which the allowable limit is an allowable upper limit of a difference between a maximum value and a minimum value of the intensity of the light coupled to the end section of the optical transmission line, indicated by the coupled light temperature characteristic, during a period from when the usage environment temperature changes from a predetermined first temperature to a predetermined second temperature.

In the second aspect of the invention, the coupled light temperature characteristic can be suppressed such that the difference between the maximum value and the minimum value of the intensity of the light coupled to the end section of the optical transmission line during the period from when the usage environment temperature changes from the predetermined first temperature to the predetermined second temperature is at the allowable upper limit or below. As a result, the change in the intensity of the light of a specific diffractive order coupled to the end section of the optical transmission accompanying the change in the usage environment temperature can be more appropriately suppressed. A more stable optical communication can be performed.

An optical element according to a third aspect is the optical element according to the first or second aspect in which the diffraction grating is formed to have a specific light temperature characteristic allowing the coupled light temperature characteristic suppressed to within the allowable limit to be obtained through addition of the specific light temperature characteristic to an emitted light temperature characteristic indicating a change in an intensity of the light emitted from the photoelectric conversion element accompanying the change in the usage environment temperature of the photoelectric conversion element. The specific light temperature characteristic indicates a change in an intensity of the light of the specific diffractive order emitted from the diffraction grating accompanying the change in the usage environment temperature.

In the third aspect of the invention, the diffraction grating can be formed to have an optimal specific light temperature characteristic for suppressing the coupled light temperature characteristic, by an emitted light temperature characteristic being taken into consideration. As a result, the coupled light temperature characteristic can be suppressed with more certainty. A more stable optical communication can be performed.

An optical element according to a fourth aspect is the optical element according the third aspect in which the diffraction grating is formed to have the specific light temperature characteristic allowing the coupled light temperature characteristic suppressed to within the allowable limit to be obtained through specification of a grating shape of the diffraction grating, a temperature coefficient of a refractive index of a formation material of the diffraction grating, and a coefficient of linear expansion of the formation material.

In the fourth aspect of the invention, the grating shape, the temperature coefficient of the refractive index, and the coefficient of linear expansion are specified. As a result, the coupled light temperature characteristic can be suppressed to within the allowable limit with more certainty.

An optical element according to a fifth aspect is the optical element according to the fourth aspect in which the grating shape of the diffraction grating includes at least one among a period, a depth of a grating groove, and a filling factor.

In the fifth aspect of the invention, the grating shape is specified by at least one among the period, the depth of the grating groove, and the filling factor. As a result, the coupled light temperature characteristic can be suppressed to within the allowable limit with more certainty.

An optical element according to a sixth aspect is the optical element according to any one of the first to fifth elements in which the photoelectric conversion element is a semiconductor laser.

In the sixth aspect of the invention, even when an adjustment mechanism for adjusting the electric current supplied to the photoelectric conversion element in adherence to the usage environment temperature is not used, or when a low-cost adjustment mechanism that cannot adjust the electric current supplied to the photoelectric conversion element with high accuracy is used, the diffraction grating can suppress the coupled light temperature characteristic to within the allowable limit. As a result, the change in the intensity of the light of a specific diffractive order coupled to the end section of the optical transmission line that accompanies the change in the usage environment temperature can be suppressed at a low cost. A stable optical communication with a superior heat resistance property can be actualized at a low cost. Moreover, size reduction of the optical module can be achieved and versatility can be improved.

An optical module holder according to a seventh aspect includes an optical element according to any one of the first to sixth aspects. The optical module holder also includes an optical transmission line attaching section for attaching an end section of an optical transmission line and a photoelectric conversion element attaching section for attaching a photoelectric conversion element capable of emitting light by an electric current being supplied. The optical element, the optical transmission line attaching section, and the photoelectric conversion element attaching section are integrally formed by a resin material.

In the seventh aspect of the invention, the change in the intensity of the light of a specific diffractive order coupled to the end section of the optical transmission line accompanying the change in the usage environment can be suppressed at a low cost. A stable optical communication having a superior heat resistance property can be performed at a low cost. As a result, an optical module holder can be actualized than can achieve size reduction of an optical module and improve versatility.

An optical module according to an eighth aspect includes an optical module holder according to the seventh aspect and a photoelectric conversion element capable of emitting light by an electric current being supplied.

In the eighth aspect of the invention, the change in the intensity of the light of a specific diffractive order coupled to the end section of the optical transmission line accompanying the change in the usage environment can be suppressed at a low cost. A stable optical communication having a superior heat resistance property can be performed at a low cost. As a result, an optical module can be actualized than can achieve size reduction and improve versatility.

An optical connector according to a ninth aspect includes an optical module according to the eighth aspect and a housing that houses the optical module.

In the ninth aspect of the invention, the change in the intensity of the light of a specific diffractive order coupled to the end section of the optical transmission line accompanying the change in the usage environment can be suppressed at a low cost. A stable optical communication having a superior heat resistance property can be performed at a low cost. As a result, an optical connector can be actualized than can achieve size reduction of an optical module and improve versatility.

### [Effect of the Invention]

In the invention, the change in the intensity of the light coupled to the end section of the optical transmission line, among the light emitted from the photoelectric conversion element, accompanying the change in the usage environment temperature can be suppressed at a low cost. Moreover, a stable optical communication having a superior heat resistance property can be performed at a low cost.

### BRIEF DESCRIPTION OF THE DRAWINGS

FIG. 1 is a configuration diagram of an optical element, an optical module holder, and an optical module according to an embodiment of the present invention;

FIG. 2 is a vertical cross-sectional view of a diffraction grating in the optical element in FIG. 1;

FIG. 3 is a schematic configuration diagram of an optical connector according to the embodiment of the present invention;

FIG. 4 is a graph showing coupled light temperature characteristics of an example and a comparative example;

FIG. 5 is a graph showing an emitted light temperature characteristic of the example;

FIG. 6 is a graph showing a temperature characteristic of diffraction efficiency for obtaining the coupled light temperature characteristic of the example;

FIG. 7 is a graph showing output characteristics of a semiconductor laser; and

FIG. 8 is a configuration diagram of an example of a conventional optical module including an adjustment mechanism for an electric current supplied to a semiconductor laser.

### DETAILED DESCRIPTION OF THE PREFERRED EMBODIMENT

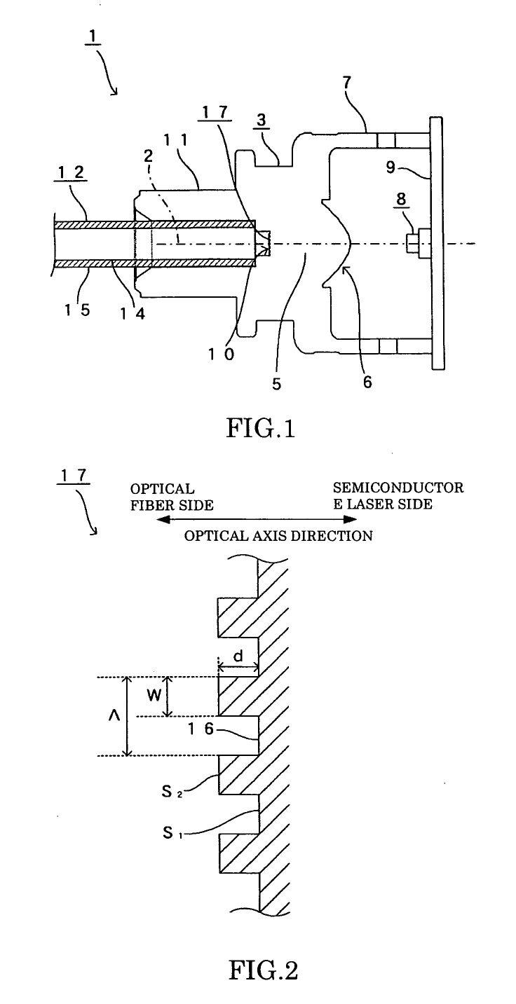

An embodiment of an optical element, an optical module holder including the optical element, an optical module, and an optical connector of the present invention will be described with reference to FIG. 1 to FIG. 6.

As shown in FIG. 1, an optical module 1 according to the embodiment has an optical module holder 3 of which a length runs long along an optical axis 2. The optical module holder 3 is, for example, integrally formed by a light-transmitting resin material, such as polyether imide (PEI), polycarbonate (PC), or polymethylmethacrylate (PMMA), being injection-molded.

The optical module holder 3 has an optical element 5 in a center of the optical module holder 3 in a length direction. An optical surface of the optical element 5 in one optical axis 2 direction (right direction in FIG. 1) is formed into an almost planoconvex shape serving as a planar, circular, convex lens surface 6.

The optical module holder 3 also has a cylindrical photoelectric conversion element attaching section 7 that extends from an outer side of the lens surface 6 in a radial direction towards one optical axis 2 direction (right direction in FIG. 1).

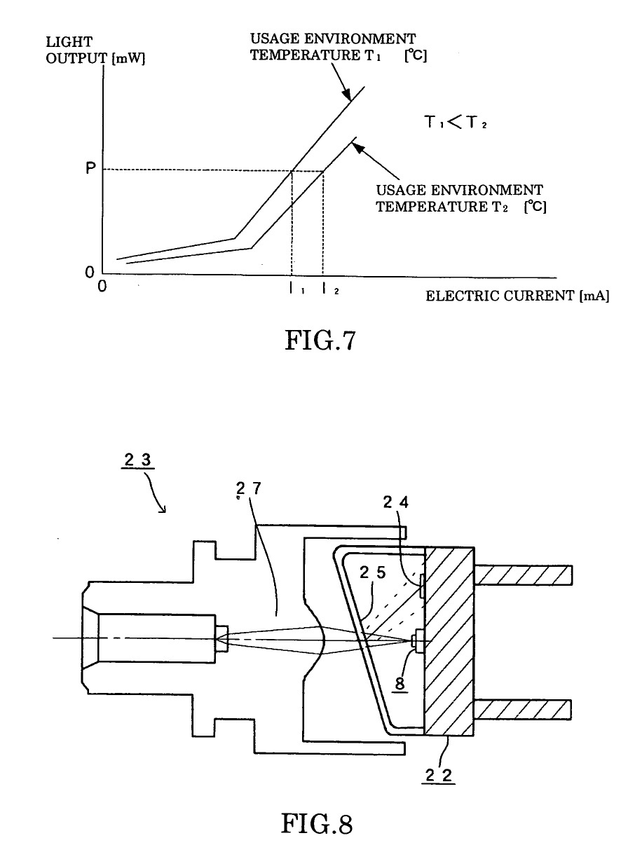

As shown in FIG. 1, a surface-mounted semiconductor laser 8 is attached to the photoelectric conversion element attaching section 1 as the photoelectric conversion element. The semiconductor laser 8 is mounted on a surface of a substrate 9 made of silicon or the like. The semiconductor laser 8 and the optical module holder 3 form the optical module 1 according to the embodiment. As shown in FIG. 7, the semiconductor laser 8 emits light by an electric current being supplied. The intensity of an emitted light increases with an increase in the supplied electric current.

Moreover, the optical module holder 3 has a cylindrical optical fiber attaching section 11 serving as an optical transmission line attaching section. The optical fiber attaching section 11 extends from an outer side of an optical surface 10 in a radial direction towards an optical axis 2 direction opposite of the direction of the photoelectric conversion element attaching section 7. The optical surface 10 faces the lens surface 6 of the optical element 5 in the optical axis 2 direction.

An optical fiber 12 is removably attached to the optical fiber attaching section 11 with a ferrule 15 that holds a fiber core 14 of the optical fiber 12.

In this way, as a result of a configuration in which the optical element 5 is disposed on an optical path between the optical fiber 12 and the semiconductor laser 8, a light emitted from the semiconductor laser 8 enters the optical element 5 from the lens surface 6. After the light is focused by the optical element 5, the light is emitted from the optical element 5 via the optical surface 10 facing the lens surface 6. The light is then coupled to an end section of the optical fiber 12 (end section in a length direction).

However, according to the embodiment, the light coupled to the end section of the optical fiber 12 is limited to a portion of the light emitted from the optical element 5.

In other words, according to the embodiment, a diffraction grating 17 is formed on the optical surface 10 facing the lens surface 6 of the optical element 5, as shown in FIG. 2. In the diffraction grating 17, a plurality of linear grating grooves 16 are aligned in a state having a constant period Λ[μm] in a period direction perpendicular to a groove direction. In the diffraction grating 17 in FIG. 2, each grating groove 16 is formed having a rectangular cross-section (rectangle shape) of a same dimension. An un-shaped surface S₂ of the grating groove 16 is formed into a planar surface that is parallel to a bottom surface S₁ of the grating groove 16.

The diffractive grating 17 attenuates an amount of light coupled to the end section of the optical fiber 12 by diffracting the light entering from the semiconductor laser 8 side and coupling only light of a specific diffractive order (such as zero-order) to the end of the optical fiber 12.

Moreover, according to the embodiment, the diffraction grating 17 suppresses a coupled light temperature characteristic to within a predetermined allowable limit.

According to the embodiment, the coupled light temperature characteristic refers to a characteristic indicating a change in an intensity of the light having the specific diffractive order coupled to the end section of the optical fiber 12. The change accompanying a change in the usage environment temperature of the semiconductor laser 8. The coupled light temperature characteristic can be a characteristic under an assumption that the electric current supplied to the semiconductor laser 8 is constant.

As the allowable limit of the coupled light temperature characteristic, various aspects can be selected depending on a concept. For example, as the allowable limit, an allowable upper limit of a difference between a maximum value and a minimum value of an intensity of the light coupled to the end section of the optical fiber 12, indicated by the coupled light temperature characteristic, during a period from when the usage environment temperature of the semiconductor laser 8 changes from a predetermined first temperature to a predetermined second temperature can be used.

Therefore, according to the embodiment, without use of an adjustment mechanism that adjusts the electric current supplied to the semiconductor laser 8 depending on the usage environment temperature of the semiconductor 8, the coupled light temperature characteristic can be modified (made closer to a flat state) by the diffraction grating 17.

As a result, the change in the intensity of the light of the specific diffractive order coupled to the end section of the optical fiber 12 accompanying the change in the usage environment temperature of the semiconductor laser 8 can be suppressed at a low cost. In addition, size reduction can be achieved through use of the surface-mounted semiconductor laser 8.

More preferably, the diffraction grating 17 has, as a specific light temperature characteristic, a specific light temperature characteristic that can allow the coupled light temperature characteristic suppressed to within the allowable limit to be obtained through addition of the specific light temperature characteristic to an emitted light temperature characteristic.

According to the embodiment, the specific light temperature characteristic refers to a characteristic indicating a change in the intensity of the light of a specific diffractive order emitted from the diffraction grating 17 accompanying the change in the usage environment temperature of the diffraction grating 17.

According to the embodiment, the emitted light temperature characteristic refers to a characteristic indicating a change in the intensity of the light emitted from the semiconductor laser 8 accompanying the change in the usage environment temperature of the semiconductor laser 8. The emitted light temperature characteristic according to the embodiment can be a characteristic under an assumption that the electric current supplied to the semiconductor laser 8 is constant.

As a result, the diffraction grating 17 can have an optimal specific light temperature characteristic for suppressing the coupled light temperature characteristic by taking into consideration the emitted light temperature characteristic. Therefore, the coupled light temperature characteristic can be suppressed with further certainty.

More preferably, in the diffraction grating 17, a grating shape, a temperature coefficient (dn/dT) of a refractive index of a formation material, and a coefficient of linear expansion of the formation material are specified. As a result, the diffraction grating 17 can have a specific light temperature characteristic allowing the coupled light temperature characteristic suppressed to within the allowable limit to be obtained.

In this case, as the grating shape, at least one among a period Λ[μm] shown in FIG. 2, a depth d[μm] of a grating groove, and a filling factor can be used. The filing factor can be determined as a value W/Λ that is a distance W[μm] in a period direction between adjacent grating grooves 16 divided by the period Λ, when the diffraction grating 17 has the rectangular grating grooves 16 as shown in FIG. 2.

Here, the applicant considers it preferable that the diffraction grating 17 can have a desired specific light temperature characteristic through specification of the grating shape, the temperature coefficient of the refractive index, and the coefficient of linear expansion, as a result of focusing on the following.

In other words, the applicant first focused on a diffraction efficiency of the diffraction grating 17 as a physical quantity that can be considered to be directly involved with the intensity of the light of a specific diffractive order emitted from the diffraction grating 17.

As an example of the diffraction efficiency, a diffraction efficiency based on a Fraunhofer diffraction is expressed by a following Expression (1)

$$\begin{matrix}Expression 1 & \\ {η}_{m} = {\vert \frac{1}{} {\int }_{0}^{⋀} exp \{ jΦ ( x ) \} exp ( j \frac{2 π mx}{} ) d x \vert}^{2} & ( 1 )\end{matrix}$$

ηₘ in Expression (1) is a diffraction efficiency of an m-order diffraction light. Λ[μm] in Expression (1) is a period of the diffraction grating. Moreover, m in Expression (1) is a diffractive order of the diffraction light. m takes on zero and positive or negative integer values.

Moreover, φ(x) in Expression (1) is a phase shift function in which the period direction of the diffraction grating is an x axis direction. The phase shift function is expressed as a following Expression (2) when the diffraction grating is a transmitting type having two levels of rectangular grating grooves, as shown in FIG. 2, in which the bottom surface of the grating groove is a first level and an un-shaped surface of the grating groove is a second level.

$$\begin{matrix}Expression 2 & \\ φ ( x ) = \{ \begin{matrix}φ & ( 0 ≦ x < a ) \\ 0 & ( a ≦ x < )\end{matrix} & ( 2 )\end{matrix}$$

in Expression 2 is a constant number that is expressed by {2πd(n−1)}/λ when a level difference, namely the depth, of the grating groove is d[μm(nm)], the refractive index of the formation material of the diffraction grating is n, and a wavelength of the light being used is λ[μm(nm)]. a in Expression (2) is the above-described filling factor.

As is clear from Expression (1) and Expression (2), if the grating shape, such as the period Λ, the depth of the grating groove, and the filling factor, and the refractive index of the formation material of the diffraction grating are specified as manufacturing conditions of the diffraction grating, diffraction efficiency unique to the specified conditions can be achieved.

Next, focus is placed on the diffraction grating having a temperature coefficient of the refractive index and a coefficient of linear expansion unique to the formation material.

In other words, in the diffraction grating, the grating shape (Λ, d, and a) changes depending on the coefficient of linear expansion of the formation material and the refractive index n changes depending on the temperature coefficient of the refractive index, when the usage environment temperature changes.

Moreover, a value of ø in Expression (2) changes with the deformation of the grating shape and the change in the refractive index as described above. A value of ηₘ determined by the value of ø being assigned to equation (1) as φ(x) also changes.

The change in the value of ηₘ accompanying the change in the usage environment temperature as described above can be called a temperature characteristic of the diffraction efficiency.

Therefore, when the temperature coefficient of the refractive index and the coefficient of linear expansion of the formation material of the diffraction grating are specified with the grating shape (Λ, d, and a), the temperature characteristic of the diffraction efficiency unique to the specified conditions can be prescribed.

As described above, because the diffraction efficiency can be considered to be a physical quantity directly involved with the intensity of the light of a specific diffractive order emitted from the diffraction grating, it can be concluded that, when the temperature characteristic of the diffraction efficiency is prescribed, the temperature characteristic of the intensity of the light of a specific diffractive order emitted form the diffraction grating, namely the specific light temperature characteristic, can be prescribed at the same time.

For this reason, as a result of the grating shape, the temperature coefficient of the refractive index, and the coefficient of linear expansion being specified as suitable values, the specific light temperature characteristic allowing the coupled light temperature characteristic suppressed to within the allowable limit to be obtained can be prescribed with certainty.

When specifying the grating shape, the temperature coefficient of the refractive index, and the coefficient of linear expansion to prescribe the specific light temperature characteristic as described above, calculations using equation (1) and equation (2) may be difficult. In this case, the grating shape, the temperature coefficient of the refractive index, and the coefficient of linear expansion can be specified through simulation to achieve a target specific temperature characteristic.

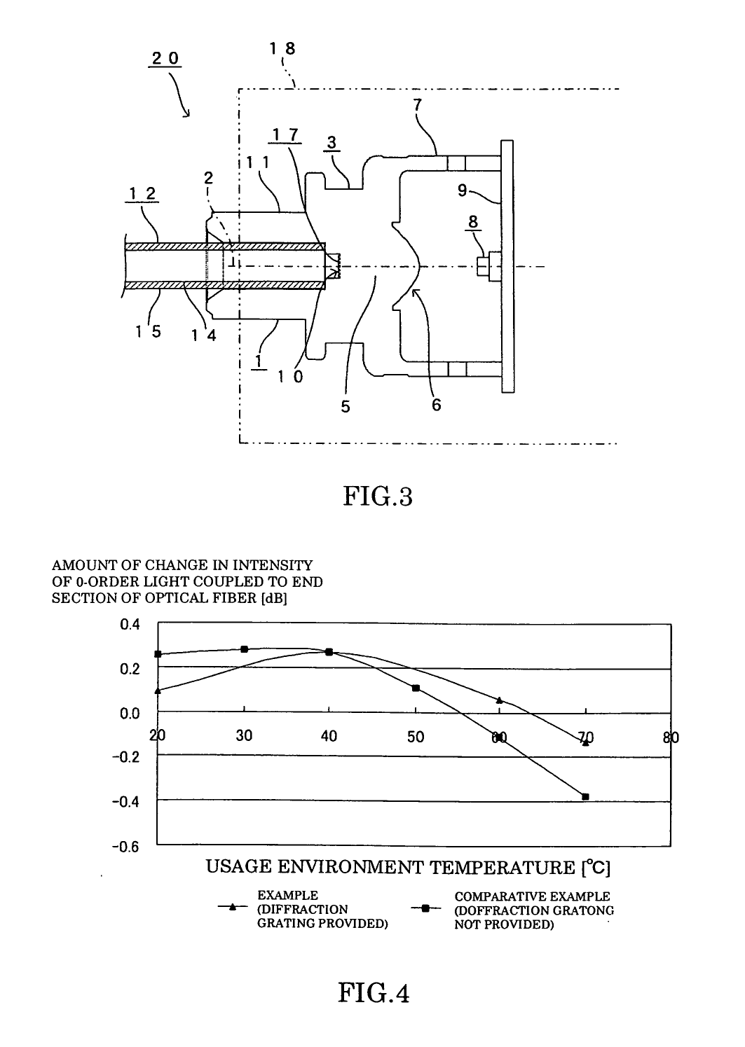

The optical module 1 according to the embodiment forms an optical connector 20 by being held within a housing 18, as shown in FIG. 3.

### EXAMPLE

In a present example, to achieve a coupled light temperature characteristic such as that shown in a graph in FIG. 4 of an example plotted with triangles, the grating shape of the diffraction grating 17, and the temperature coefficient of the refractive index and the coefficient of linear expansion of a resin material forming the diffraction grating 17 are respectively specified.

A horizontal axis in FIG. 4 indicates the usage environment temperature [° C.] of the semiconductor laser 8. A vertical axis indicates an amount of change [dB] in the intensity [W/cm2] of a zero-order light serving as the light of a specific diffractive order coupled to the end section of the optical fiber 12. The vertical axis in FIG. 4 indicates, for example, the amount of change in the intensity of the zero-order light of which a reference intensity is an intensity of the zero-order light (not shown) equivalent to a point of origin, 0.0 [dB]. Therefore, the vertical axis in FIG. 4 is the amount of change in the intensity of the zero-order light, rather than the intensity of the zero-order light itself. However, graphical forms always match between the characteristic of the change in the amount of change and the characteristic of the change in the intensity of the zero-order light itself. Therefore, the graph of the example in FIG. 4 can be handled as the characteristic (coupled light temperature characteristic) indicating the change in the intensity of the zero-order light coupled to the end section of the optical fiber 12 accompanying the change in the usage environment temperature.

In the coupled light temperature characteristic shown in the example in FIG. 4, a difference between the maximum value and the minimum value of the intensity of zero-order light coupled to the end section of the optical fiber 12, indicated by the coupled light temperature characteristic, during a period of when the usage environment temperature of the semiconductor laser 8 changes from 20 C (first temperature) to 70 C (second temperature) is at or below a light intensity width equivalent to 0.5 [dB], serving as the allowable upper limit (allowable limit).

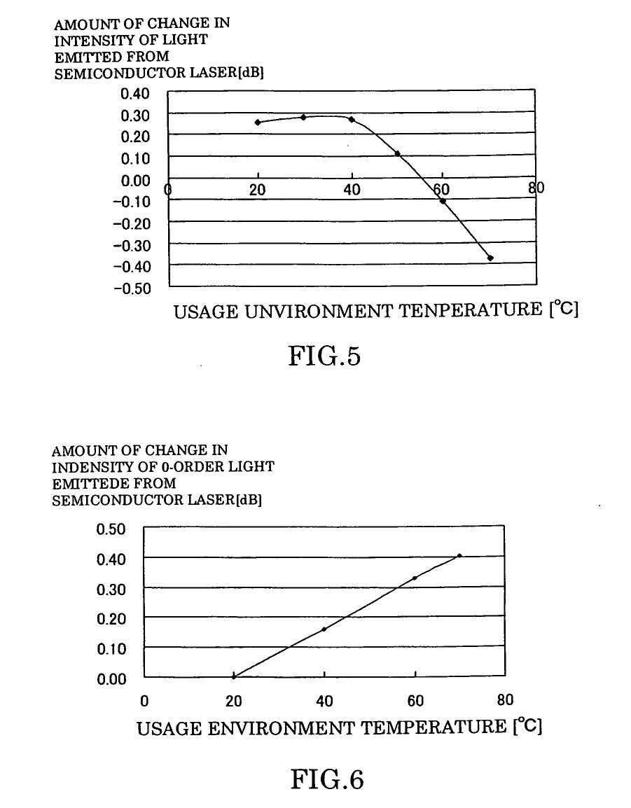

To achieve a coupled light temperature characteristic such as this, first, the emission light temperature characteristic of the semiconductor laser 8 being used is grasped. Here, the emission light temperature characteristic in the present example is a characteristic shown in a graph in FIG. 5. A horizontal axis in FIG. 5 indicates the usage environment temperature [° C.]. A vertical axis indicates the amount of change [dB] in the intensity of the light emitted from the semiconductor laser 8. The vertical axis in FIG. 5 indicates, for example, the amount of change in the intensity of the light of which a reference intensity is an intensity of light (not shown) equivalent to the point of origin, 0.0 [dB]. Therefore, the vertical axis in FIG. 5 is the amount of change in the intensity of the light, rather than the intensity of the light itself. However, graphical forms always match between the characteristic of the change in the amount of change and the characteristic of the change in the intensity of the light itself. Therefore, the graph in FIG. 5 can be handled as the characteristic (emitted light temperature characteristic) indicating the change in the intensity of the light emitted from the semiconductor laser 8 accompanying the change in the usage environment temperature. The emission light temperature characteristic can be obtained by actual measurement.

Next, through subtraction of the emission light temperature characteristic shown in the example in FIG. 5 from the coupled light temperature characteristic shown in the graph of the example in FIG. 4, a specific light temperature characteristic such as that shown in a graph in FIG. 6 is obtained. A horizontal axis in FIG. 6 indicates the usage environment temperature [° C.] of the diffraction grating 17. A vertical axis indicates the amount of change [dB] in the intensity of the zero-order light emitted from the diffraction grating 17. The vertical axis in FIG. 6 indicates, for example, the amount of change in the intensity of the zero-order light of which a reference intensity is an intensity of the zero-order light (not shown) equivalent to a point of origin, 0.0 [dB]. Therefore, the vertical axis in FIG. 6 is the amount of change in the intensity of the zero-order light, rather than the intensity of the zero-order light itself. However, graphical forms always match between the characteristic of the change in the amount of change and the characteristic of the change in the intensity of the zero-order light itself. Therefore, the graph in FIG. 6 can be handled as the characteristic (specific light temperature characteristic) indicating the change in the intensity of the zero-order light emitted from the diffraction grating 17 accompanying the change in the usage environment temperature.

The grating shape of the diffraction grating 17, and the temperature coefficient of the refractive index and the coefficient of linear expansion of the resin material forming the diffraction grating 17 are then respectively specified by simulation or the like, to obtain the specific light temperature characteristic shown in FIG. 6.

As a result, a diffraction grating 17 can be obtained of which the period is 5 μm, the depth of the grating groove is 3.05 μm, the refractive index at a usage wavelength of 850 nm is 1.64, and the coefficient of linear expansion of the resin material is −5.6×10⁻⁵ [/K].

When the optical module 1 is used in which the diffraction grating 17 of the invention, obtained as described above, is formed, as shown in the graph of the example in FIG. 4, the coupled light temperature characteristic can be suppressed to within the allowable limit. Specifically, the difference between the maximum value and the minimum value of the intensity of the zero-order light coupled to the end section of the optical fiber 12 during the period of when the usage environment temperature of the semiconductor laser 8 changes from 20 C to 70 C can be a light intensity width equivalent to 0.41 [dB].

In FIG. 4, as a comparative example, a graph plotted with squares is also shown indicating the coupled light temperature characteristic when the diffraction grating is not formed in the optical element. As shown in the graph of the comparative example, in the comparative example, the difference between the maximum value and the minimum value of the intensity of the zero-order light coupled to the end section of the optical fiber during the period of when the usage environment temperature changes from 20 C to 70 C is a light intensity width equivalent to about 0.60 [dB], slightly exceeding the allowable limit. Therefore, it is clear that performance is poor compared to the present invention.

As described above, in the present invention, the coupled light temperature characteristic can be suppressed to within the allowable limit by the diffraction grating 17, without adjustment of the electric current supplied to the semiconductor laser being required. Therefore, the change in the intensity of the light of a specific diffractive order coupled to the end section of the optical fiber 12 accompanying the change in the usage environment temperature can be suppressed at a low cost. Moreover, a stable communication having a superior heat resistance property can be performed at a low cost.

The present invention is not limited by the above-described embodiment. Various modifications can be made as required.

For example, the present invention can suppress the coupled light temperature characteristic to within the allowable limit by a function of the diffraction grating 17, even when the present invention is applied to the CAN package-type semiconductor laser including the adjustment mechanisms 24 and 25 that adjust the electric current supplied to the semiconductor laser 8, as shown in FIG. 8. Therefore, a stable optical communication can be performed even when the adjustment mechanism included in the CAN package is not an expensive mechanism allowing the electric current to be controlled with high accuracy.

The present invention can be effectively applied to an element other than the semiconductor laser as long as the photoelectric conversion element is that in which the intensity of the light emitted by being supplied with the electric current is temperature-dependent.

Moreover, the light of a specific diffractive order coupled to the end section of the optical fiber 12 is not necessarily limited to the zero-order light. Various modifications can be made. A diffraction light of 1-order or more can be coupled. Alternatively, two or more types of light having different diffractive orders can be coupled.

The diffraction grating of the present invention is not limited to that having rectangular grating grooves. For example, the grating grooves can be wedge-shaped or blaze-shaped. The diffraction grating can also have a bracelet-shaped structure in which a plurality of planar ring-shaped grating grooves having different radii are concentrically disposed.

However, when the optical module including the diffraction grating of the present invention and an optical module for reception including a light-receiving element are provided in parallel along a direction perpendicular to a paper surface in FIG. 3, the diffraction grating is preferably the diffraction grating 17 having the linear grating grooves 16 shown in FIG. 3. The diffraction light from the diffraction grating 17 having the linear grating grooves 16 disposed in a direction such as that shown in FIG. 3 spreads in the upward and downward directions in FIG. 3. Therefore, intrusion of the diffraction light as a stray light onto the optical path of the optical module for reception can be prevented. A bidirectional optical communication can be performed with little error.

What is claimed is:

1. An optical element that, in a state in which the optical element is disposed on an optical path between an optical transmission line and a photoelectric conversion element capable of emitting light by an electric current being supplied, couples a light emitted from the photoelectric conversion element to an end section of the optical transmission line, the optical element comprising:
a diffraction grating that diffracts light entering from the photoelectric conversion element side and couples a light of a specific diffractive order to the end section of the optical transmission line,
wherein, the diffraction grating is formed to suppress a coupled light temperature characteristic to within a predetermined allowable limit, the coupled light temperature characteristic indicating a change in an intensity of the light coupled to the end section of the optical transmission that accompanies a change in a usage environment temperature of the photoelectric conversion element.

2. The optical element according to claim 1, wherein:
the allowable limit is an allowable upper limit of a difference between a maximum value and a minimum value of the intensity of the light coupled to the end section of the optical transmission line, indicated by the coupled light temperature characteristic, during a period from when the usage environment temperature changes from a predetermined first temperature to a predetermined second temperature.

3. The optical element according to claim 1, wherein:
the diffraction grating is formed to have a specific light temperature characteristic allowing the coupled light temperature characteristic suppressed to within the allowable limit to be obtained through addition of the specific light temperature characteristic to an emitted light temperature characteristic indicating a change in an intensity of the light emitted from the photoelectric conversion element accompanying the change in the usage environment temperature of the photoelectric conversion element, the specific light temperature characteristic indicating a change in an intensity of the light of the specific diffractive order emitted from the diffraction grating accompanying the change in the usage environment temperature.

4. The optical element according to claim 3, wherein:
the diffraction grating is formed to have the specific light temperature characteristic allowing the coupled light temperature characteristic suppressed to within the allowable limit to be obtained through specification of a grating shape of the diffraction grating, a temperature coefficient of a refractive index of a formation material of the diffraction grating, and a coefficient of linear expansion of the formation material.

5. The optical element according to claim 4, wherein:
the grating shape of the diffraction grating includes at least one among a period, a depth of a grating groove, and a filling factor.

6. The optical element according to any one of claims 1 to 5, wherein:
the photoelectric conversion element is a semiconductor laser.

7. An optical module holder comprising:
an optical element according to claim 1;
an optical transmission line attaching section for attaching an end section of an optical transmission line; and
a photoelectric conversion element attaching section for attaching a photoelectric conversion element capable of emitting light by an electric current being supplied;
wherein, the optical element, the optical transmission line attaching section, and the photoelectric conversion element attaching section are integrally formed by a resin material.

8. An optical module comprising:
an optical module holder according to claim 7; and
a photoelectric conversion element capable of emitting light by an electric current being supplied.

9. An optical connector comprising:
an optical module according to claim 8; and
a housing holding the optical module.
